(19) United States
(12) Patent Application Publication
(10) Pub. No.: US 2004/0086262 A1
(43) Pub. Date: May 6, 2004

(54) Video data reproducing system and method

(75) Inventors: Masaru Igawa, Kawasaki (JP); Koichi Shibata, Kamakura (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/442,527

(22) Filed: May 20, 2003

(30) Foreign Application Priority Data
Nov. 6, 2002 (JP) 2002-322017

(51) Int. Cl. H04N 5/783

(52) U.S. Cl. 386/68; 386/111

(57) ABSTRACT

When receiving a request for reverse reproduction of a first video image from a terminal, a server transmits first compressed video data corresponding to the request. The terminal, which is connected to the server, decodes the first compressed video data transmitted from the server. The reverse reproduction of the decoded first video data is performed. Concurrently with the decoding process, a request for reverse reproduction of a second video image that is a continuation of said first video image is transmitted to the server. When receiving the request for the reverse reproduction of the second video image, the server transmits second compressed video data corresponding to the request to the terminal. The terminal decodes the second compressed video data transmitted from the server and performs the reverse reproduction of the decoded second video data.

### FIELD OF THE INVENTION

The present invention relates to a control technique of an audio-visual terminal for reproducing and displaying video data and, in particular, it relates to a video reproducing technique for performing reverse reproduction.

### BACKGROUND OF THE INVENTION

Conventionally, a technique for reproducing a video image recorded on a video tape and the like by an apparatus such as a videocassette recorder has become widespread. Then, as a technique for compressing video and sound data such as MPEG has been established, it becomes possible to reproduce video data stored on a hard disk by using a PC (personal computer) Further, by distributing video data stored on a hard disk in a VOD (video on demand) server to each terminal, each terminal can reproduce video data stored not only on a local hard disk but also on the VOD server.

The videocassette recorder for reproducing the video data on the video tape cannot only replay the video tape normally, but also can perform special reproduction such as frame advance, pause, fast advance and fast reverse. Therefore, even when the video data is reproduced on the PC, it may also be required that such special reproduction can be performed.

The video compression method using a motion compensation predicting technique such as MPEG, which has been developed on the premise that the video image would be reproduced in a normal direction, has a problem in that the reproduction cannot be started from an arbitrary frame.

A technique for performing reverse reproduction of a MPEG image stored in a VOD server is disclosed, for example, in Japanese Patent Application Laid-Open 2000-209529. This technique implements reverse reproduction in a VOD server-client system by preliminarily encoding frame images, which are obtained through decoding of MPEG data, in a reverse order and storing on a hard disk and, then, distributing the reversed image data in the case of reverse reproduction.

### SUMMARY OF THE INVENTION

However, the conventional technique mentioned above has a problem in that a large hard disk storage capacity is consumed in the server. Further, as this technique is based on the premise that I-pictures (intra-coded pictures), which can be displayed on a frame-by-frame basis, are inserted at regular intervals, there is another problem that this technique cannot be applied if the I-pictures are not inserted at midpoints of the MPEG video image at all, such as in the case of MPEG-4. It is because, in the conventional method mentioned above, a string of the frame images are created in the reverse order by using the I-pictures disposed at regular intervals as starting points.

Further, when the audio-visual terminal receives MPEG distribution from the VOD server to display the video image, the reverse reproduction cannot always be possible in some conditions, such as a low transmission rate or reproduction at an accelerated speed. Therefore, the reverse reproduction may be performed in some conditions and, if the reverse reproduction is not possible, it is necessary to provide an alternative means, which can be utilized selectively.

It is an object of the present invention to provide a technique for performing reverse reproduction continuously in an audio-visual terminal that creates and displays frame images from video data based upon a motion compensation predicting algorithm.

The present invention provides a video reproducing system that is configured as described below and that includes a server for storing a video image, and a terminal for reproducing the video image. When receiving a request for reverse reproduction of a first video image from the terminal, the server transmits first compressed video data corresponding to the request to the terminal. The terminal decodes said first compressed video data transmitted from said server, performs the reverse reproduction of the decoded first video data and, concurrently with said decoding process, transmits a request for reverse reproduction of a second video image that is a continuation of said first video image to said server. The server transmits second compressed video data corresponding to the request to said terminal and, then, the terminal decodes said second compressed video data transmitted from the server and, if the decoding of said second compressed video data is completed before the reverse reproduction of said first video data is finished, the terminal performs the reverse reproduction of said second video data successively after the reverse reproduction of said first video data.

### BRIEF DESCRIPTION OF THE DRAWINGS

FIG. 1 is a diagram showing an exemplary internal configuration of an audio visual terminal;

FIG. 2 is a diagram showing an exemplary environment to which a video reproducing technique of the present invention is applied;

FIG. 3 is a diagram for describing a conventional reverse reproducing method;

FIG. 4 is a diagram for describing a reverse reproducing technique of an embodiment of the present invention;

FIGS. 5(a) to 5(d) are diagrams showing an example of transition of frame images left in an image buffer at the time of normal reproduction;

FIGS. 6(a) to 6(d) are diagrams showing an example of transition of frame images created and deleted in the image buffer at the time of reverse reproduction;

FIG. 7 is a diagram showing an exemplary configuration of a management table 211;

FIG. 8 is a flow chart showing a control procedure for performing reverse reproduction in an embodiment of the present invention;

FIGS. 9(a) to 9(c) are diagrams for describing image transition behavior in various reproduction modes; and

FIG. 10 is a diagram showing an exemplary display screen of a display 202.

### DETAILED DESCRIPTION OF THE INVENTION

Hereinafter, a preferred embodiment of the present invention will be described with reference to the drawings. Here, it is to be noted that the preferred embodiment is not intended to limit the present invention.

FIG. 2 is a diagram showing an exemplary environment to which a video reproducing technique of the present invention is applied. A VOD server 101 has features for sending compressed video data stored therein when it receives a request for video distribution. An audio-visual terminal 102 is a video reproducing apparatus that has features for transmitting the request for video distribution to the VOD server 101, receiving the compressed video data sent from the VOD server 101 and, then, decoding the compressed video data and displaying it on a screen. The audio-visual terminal 102 has a GUI (graphical user interface) so as to perform reproduction and other processes based on a manipulation by a viewer. A network 100 transfers information between the VOD server 101 and the audio-visual terminal 102.

Here, the “compressed video data” refers to data created by compressing video information using a motion compensation predicting technique such as MPEG. The MPEG video data consists of intra-coded pictures (hereinafter referred to as the “I-pictures ”) and non-intra coded pictures by motion compensation.

A known audio-visual terminal receives compressed video data sent from the VOD server 101 to perform normal reproduction. Here, the “normal reproduction” means that the compressed video data is reproduced at the same speed as the original video image from which the compressed video data has been created. In such known audio-visual terminal, when the MPEG compressed video data is distributed, it is difficult to perform reverse reproduction on the terminal.

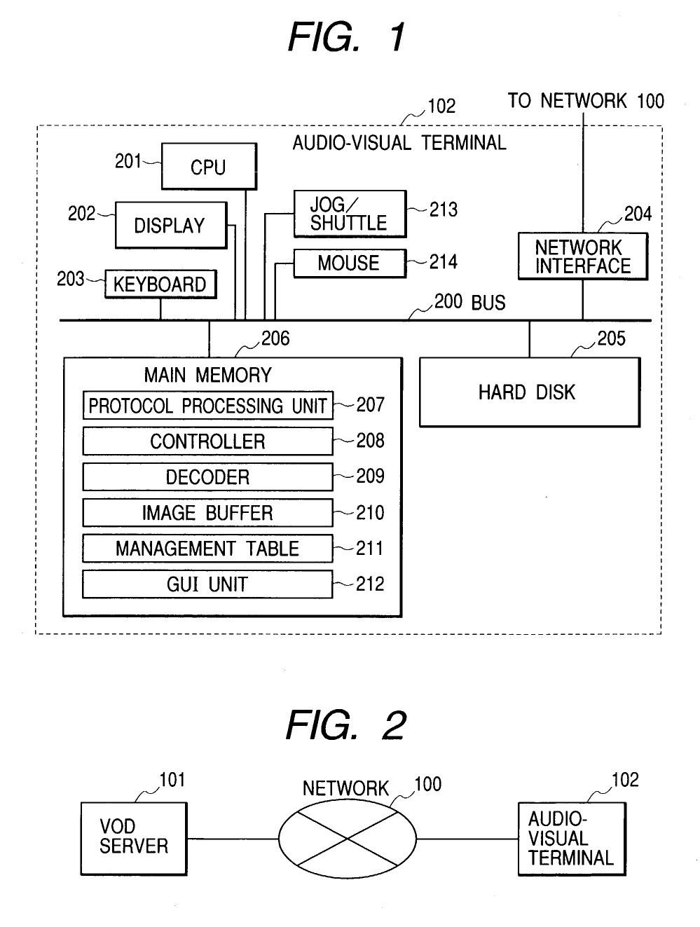

FIG. 1 is a diagram showing an internal configuration of the audio-visual terminal 102. The audio-visual terminal 102 is a computer comprised of a bus 200, a CPU 201, a display 202, a keyboard 203, a network interface 204, a hard disk 205, a main memory 206, a jog/shuttle 213, a mouse 214 and so on. The bus 200 takes charge of communication between a plurality of the hardware devices mentioned above. The display 202, the keyboard 203, the jog/shuttle 213 and the mouse 214 take charge of input/output of information from/to the viewer. In particular, the jog/shuttle 213 is a hardware device used for specifying a video reproduction mode. The network interface 204, the hard disk 205 and the main memory 206 are accessed by the CPU 201 via the bus 200.

The main memory 206 reserves an area for storing a plurality of programs and data. The main memory 206 stores a protocol processing unit 207, a controller 208, a decoder 209, an image buffer 210, a management table 211 and a GUI unit 212. The protocol processing unit 207 is a program for creating a message sent to the network 100 and interpreting a message received from the network. The controller 208 controls overall operations of the protocol processing unit 207, the decoder 209, the image buffer 210 and the management table 211. The decoder 209 is a program for decoding video data compressed by the MPEG method to restore the video image. The image buffer 210 is a storage area for holding the frame images restored by the decoder 209. Focusing on the image buffer 210, the decoder 209, the protocol processing unit 207, the network 100 and the VOD server 101 can also be considered as means for supplying the frame images to the image buffer 210. The management table 211 is a table for managing the frame images in the image buffer. The GUI unit 212 is a program for providing a user interface when the viewer inputs/outputs information through the display 202, the keyboard 203, the jog/shuttle 213 and the mouse 214. The CPU 201 executes the programs on the main memory 206.

Here, a data flow and a process procedure when the viewer views video information on the audio-visual terminal will be described. When the viewer issues a video reproduction command to the GUI unit 212 via any of the input devices, the protocol processing unit 207 creates a message corresponding to the video reproduction command. The message is sent out to the network 100 via the bus 200 and the network interface 204. When compressed video data arrives as a network message from the network 100, the message is sent to the protocol processing unit 207 via the network interface 204 and the bus 200. The protocol processing unit 207 derives the compressed video data from the network message and transfers it to the decoder 209. The decoder 209 decodes the compressed video data to create frame images, which are stored in the image buffer 210. The GUI unit 212 displays the frame images on the display 202 successively and outputs sound information to a speaker (not shown) so that the viewer can view the video image. The viewer can specify via the input devices not only normal reproduction but also special reproduction such as reverse. In contrast to the normal reproduction in which the protocol processing unit 207 creates the message for the normal reproduction command, the special reproduction differs in that a message for the special reproduction command is created and sent out to the network 100. Further, as its result, in the case of the special reproduction, data different from the one in the normal operation is sent from the VOD server and a different process is performed in the audio-visual terminal 102. The video reproducing technique of the present invention is, in particular, directed to reverse reproduction among other special reproduction modes.

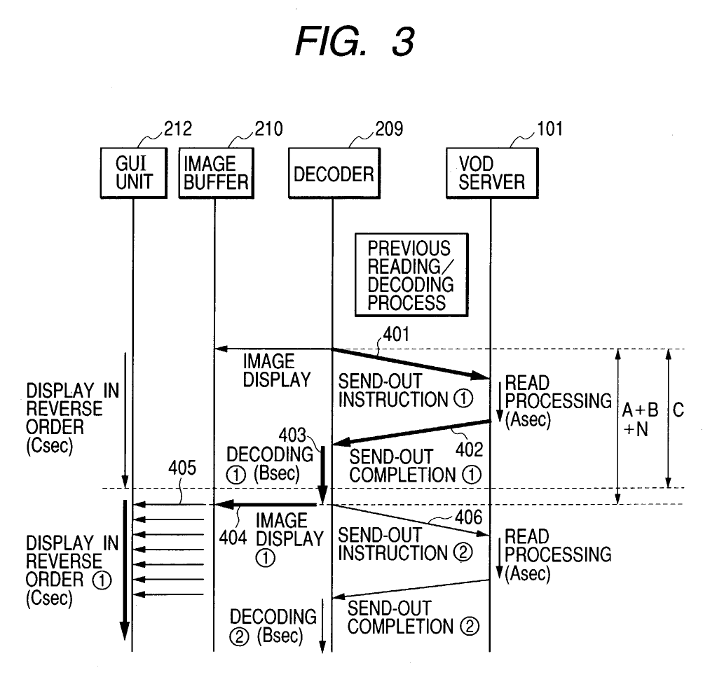

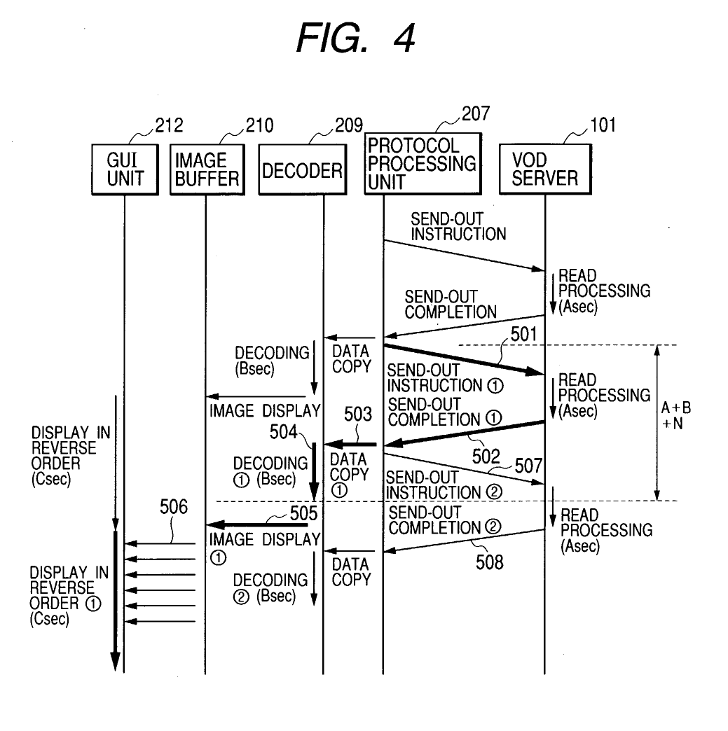

Next, the reverse reproduction method will be described with reference to FIGS. 3 and 4. First, with reference to FIG. 3, a problem that is likely to occur when the reverse reproduction is performed in the VOD server/client system will be described. Then, with reference to FIG. 4, the video reproducing method of this embodiment will be described.

As described below, in the conventional audio visual terminal receiving the MPEG data, the reverse reproduction cannot be performed properly according to the method shown in FIG. 3. When the reverse reproduction is started, the decoder 209 first sends a MPEG data send-out instruction to the VOD server 101 (arrow 401). At this time, the MPEG data to be read out is restricted to a fixed number of bytes. In response to the instruction, the VOD server 101 reads out the MPEG data from a storage device in the VOD server 101 and sends it to the decoder 209 (arrow 402). Receiving the MPEG data, the decoder 209 decodes the data (arrow 403). When the decoding is completed, the decoder 209 stores the obtained frame images in the image buffer 210 (arrow 404). The GUI unit 212 receives the frame images in the image buffer 210 to display on the display 202 in reverse order (arrow 405). Concurrently with this displaying operation, the decoder 209 sends the next send-out instruction to the VOD server 101 (arrow 406). Hereinafter, the same steps are repeated. As a consequence, the reverse reproduction is implemented.

However, if it takes a longer time to transfer the MPEG data from the VOD server 101 to the decoder 209, the completion of the decoding process and, thus, the issue of the next send-out instruction by the decoder 209 will be delayed. As a consequence, the next frame images may not be transferred to the GUI unit 212 successively after the previous transfer. In other words, from the viewer's viewpoint, it may seem that the reverse reproduction repeats a behavior to go forward for a while and then stop for a short time and, then, go forward for a while and then stop for a short time again.

Assuming that a time after the decoder 209 issues the send-out instruction to the VOD server 101 till the decoder 209 receives the data completely is A, a time to transfer information on the network is N, a time to decode the data is B, and a reverse reproduction time to display the data obtained as a result of one MPEG data transmission is C, if the following expression can be established, the reverse reproduction will be interrupted every time the MPEG data is transmitted, as described above:

A+B+N>C

In view of the above problem, a method for improving the configuration of the audio-visual terminal to minimize the effect of transmission time on the network will be described hereunder.

FIG. 4 shows a process flow when the reverse reproduction is performed in the audio-visual terminal to which the video reproducing method of the present invention is applied. The configuration shown in FIG. 4 is characterized in that it comprises the protocol processing unit 207. The protocol processing unit 207 operates independently of the operation of the decoder 209 so that the frame images in the reverse reproduction can be displayed without interruption.

Hereinafter, this method will be described following the process flow.

When the reverse reproduction is started, the protocol processing unit 207 issues a send-out instruction to the VOD server 101 (arrow 501). The send-out instruction includes a range of frame numbers of the requested frames. Receiving the send-out instruction, the VOD server 101 reads out MPEG data in the hard disk and sends it to the protocol processing unit 207 (arrow 502). Receiving the MPEG data in normal order, the protocol processing unit 207 immediately sends the MPEG data to the decoder 209 (arrow 503). The decoder 209 receives and decodes the data (arrow 504). The decoder transfers the frame images created by decoding to the image buffer 210 (arrow 505). The GUI unit 212 receives the frame images in the image buffer 210 to display on the display 202 in reverse order (arrow 506). On the other hand, immediately after the MPEG data is transferred to the decoder 209, the protocol processing unit 207 can issue the send-out instruction for next data to the VOD server 101 (arrow 507). Hereafter, by repeating such procedure, the reverse reproduction can be performed. More specifically, as the decoding process in the decoder 209 and the data receiving process in the protocol processing unit 207 can be performed concurrently, in spite of the fact that it takes time to transfer the data on the network 100, the reverse reproduction can be performed without interruption. In FIG. 4, if the lowermost point of arrow 504, or the time when the decoding process is completed is earlier than the time when the reproduction of the video image resulting from the previously decoded data is completed, the continuous reverse reproduction can be performed.

Assuming that a time after the protocol processing unit 207 issues the send-out instruction to the VOD server 101 till the protocol processing unit 207 receives the data completely is A, a time to transfer the data on the network is N, and a reverse reproduction time to display the data obtained as a result of one MPEG data transmission is C, if the following expression can be established, the reverse reproduction can be performed without interruption:

A+N<C

Here, a method for obtaining A, N and C will be described. A is typically a quite small and thus negligible value. N can be obtained from the following equation:

N=C×“bit rate”×“the number of multiplication of reproduction speed”/“transmission rate”

C may be an arbitrary short time. For example, C may be 3 seconds. The bit rate is the number of data bits per second required for reproducing the video data, which can be obtained from the MPEG data. By substituting these values into the expression shown above, it can be seen that the reverse reproduction can be performed smoothly if the following expression can be established:

“bit rate”×“the number of multiplication of reproduction speed”<“transmission rate”

where the transmission rate is a transmission throughput of the network 100.

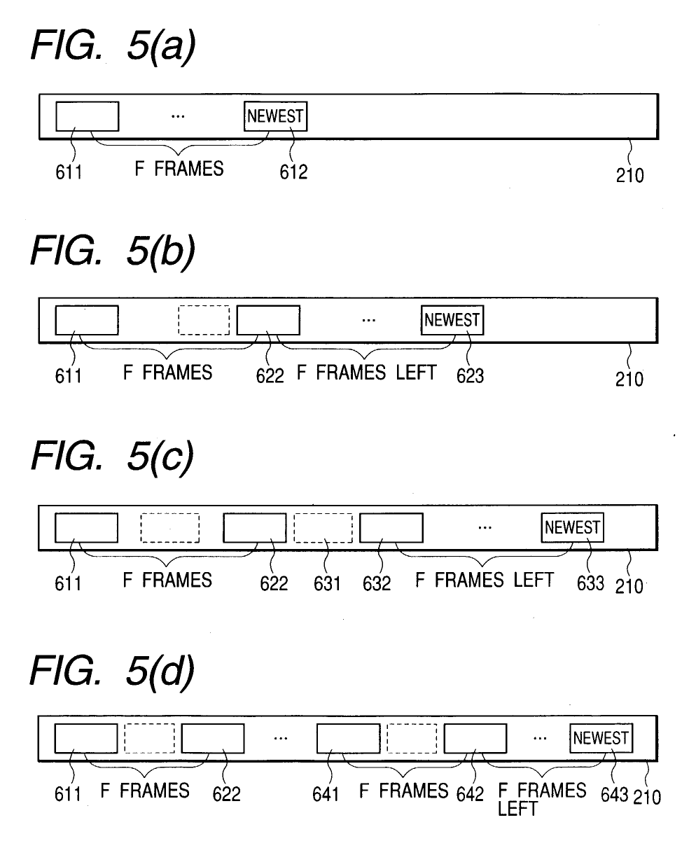

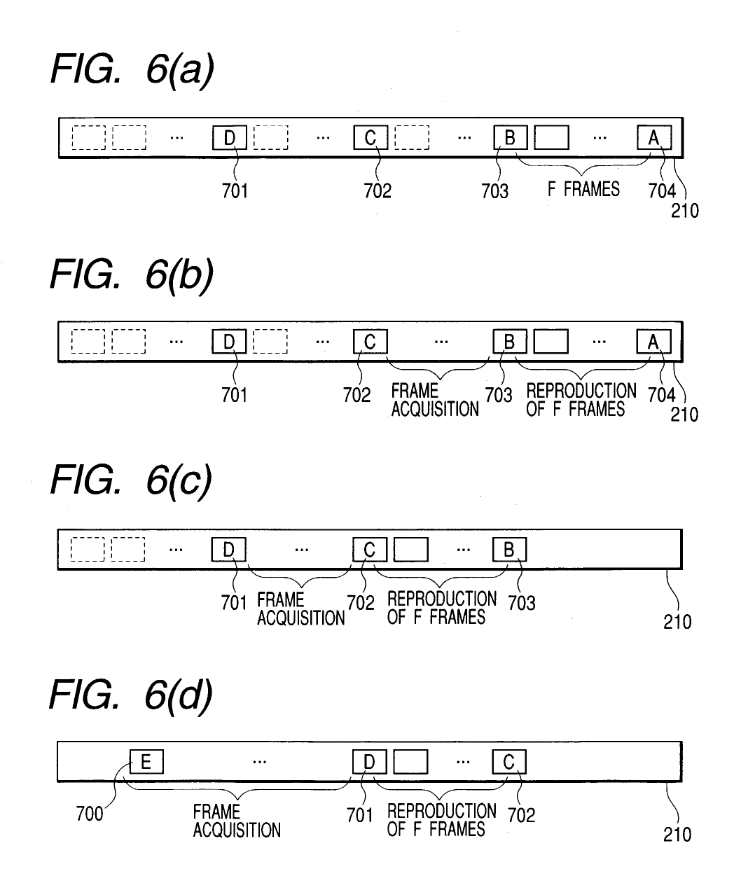

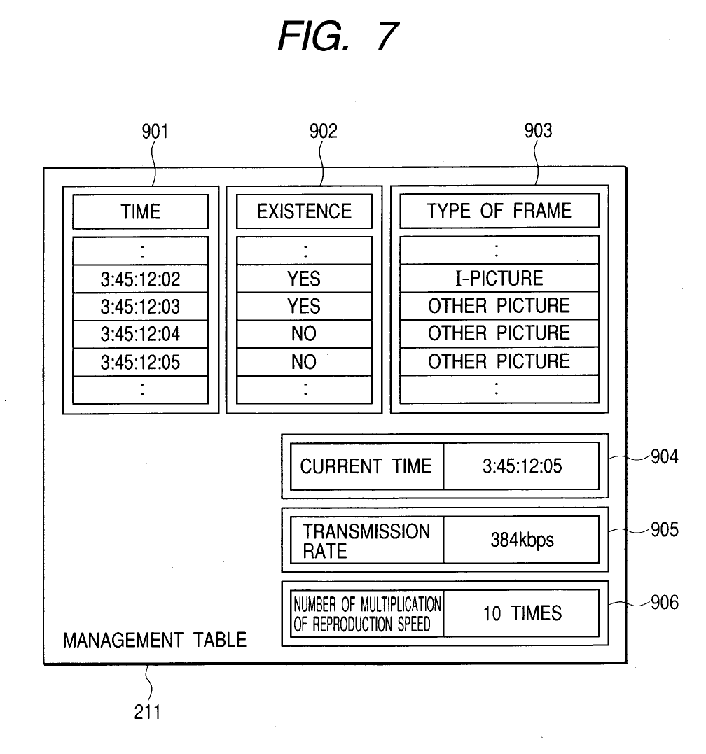

Next, with reference to FIGS. 5(a) to 5(d) and FIGS. 6(a) to 6(d), a procedure in which the controller 208 creates and deletes frame images in the image buffer 210 will be described. The image buffer 210 is always managed by the management table 211. The management table 211 will be described later.

During reproduction, as the controller 208 does not delete the displayed frame images in the image buffer 210 immediately after reproduction, when the reverse reproduction is started, first several frames can be displayed without delay. FIG. 5(a) to 5(d) are diagrams showing transition of the frame images left in the image buffer 210 after normal reproduction. At first, while there are only a few frame images, all frame images are left. FIG. 5(a) shows a state in which the number of the frame images reaches a given number F. 611 is the first frame image and 612 is the newest frame image. Till the number of the frame images reaches F, all frame images are left. When the number of the displayed frame images exceeds F, all of the newest F frame images are left but all frames older than these are deleted except the first frame image 611. Every time when one newest frame image is added to the image buffer 210, one frame image that is immediately older than the newest F frame images is deleted from the image buffer 210. After such process is repeated several times, as shown in FIG. 5(b), the moment when (2×F−1) frame images have been displayed will come. Here, 623 is the newest frame image. 622 is the F-th newest frame. All frame images between 622 and 623 are kept. All frame images between 611 and 622 are deleted. In this state, when the next frame image is added newly, the frame image 622 is not deleted. In other words, the F-th from the first frame image is not deleted. Then, when one more frame image is added, the frame next to 622 on the right side is deleted. This state is shown in FIG. 5(c). Specifically, in this state, the first frame image 611, the frame image 622 that is the F-th from the first frame image on the right side, the newest frame image 633, and all frame image between the newest frame image and the frame image 632 that is F-th from the newest frame image on the left side are left. The frame image that has been finally deleted is shown as 631. Then, in this state, when a new frame is added, the frame image 632 is deleted next. In other words, the newest F frame images are kept. As the process for adding and deleting frame images proceeds, when the number of frame images to be deleted reaches F−2, the deleting process is once omitted. In other words, the (2×F−1)-th from the first frame image is not deleted. As the process proceeds further in this manner, the image buffer 210 comes into the state in which the first frame image 611, the {nF−(n−1)}-th frame images (n=1, 2, . . . ) and the newest F frame images are all left. The longer the process proceeds, the more the storage area of the image buffer 210 is consumed. Therefore, the image buffer 210 will eventually come into the state in which there is no remaining capacity of the image buffer 210. This state is shown in FIG. 5(d). In this state, if a new frame image is added next, the frame image 642 must be left. But, as there is no remaining capacity of the image buffer in this state, the oldest frame image 611 is deleted to add the new frame image.

As the process proceeds as described above, the image buffer 210 is maintained in the state in which the newest F frames are always kept and, among the frame images older than the newest F frames, one every F−1 frame images are kept. As described above, after the frame images have been reproduced at normal speed, the controller 208 performs the control to leave the newest successive frame images and the older non-successive frame images in the image buffer 210. When the reverse reproduction is started, the reverse video image can be displayed immediately by transferring the newest F frame images to the GUI unit 212 and, therefore, the viewer's request can be accommodated quickly. The effect of leaving the one every F−1 older frames will be discussed in the description with reference to FIGS. 6(a) to 6(d) later.

Next, with reference to FIGS. 6 (a) to 6 (d), a process flow in which the controller 208 stores and deletes the frame images in the image buffer 210 when the reverse reproduction is performed will be described.

The reverse reproduction is typically performed after the normal reproduction has been performed. As described above with reference to FIGS. 5(a) to 5(d), after the normal reproduction, the frame images are left in the image buffer 210. This state is shown in FIG. 6(a). Specifically, in this state, all F frames from the newest frame 704 to 703 are kept. The frame images 702 and 701 are older than the frame images from 704 to 703 and kept at predetermined frame intervals. FIG. 6(b) shows the state in which the reverse reproduction is started. When the reverse reproduction is started, the frame images from 704 to 703 are immediately transferred to the GUI unit 212 in a last-in, first-out manner. The GUI unit 212 displays the transferred frame images. As a result, the reverse reproduction is performed. At the same time, the controller 208 requests the compressed video data between the frame image 703 and the frame image 702 to the VOD server 101via the protocol processing unit 207. Then, the protocol processing unit 207 receives the MPEG data and the decoder 209 performs the decoding process. The resultant frame images are stored in the image buffer 210 so that these frame images are logically inserted between the frame images 703 and 702. FIG. 6(c) shows the state in which these processes are completed. Based on the MPEG data obtained from the VOD server 101, all frame images from 703 to 702 are stored. By transferring these frame images from 703 to 702 sequentially, the reverse reproduction is performed. At the same time, the frame images between the frame image 702 and the frame image 701 are obtained and stored according to the procedure described above. Such process can be continued so long as the older frame images such as the frame image 701 are stored in the image buffer 210 in advance at predetermined frame intervals.

Summing up the above, if the older frames are stored at the rate of one every predetermined number of frames, by starting from the stored older frames, the reverse reproduction employing the predetermined number of frame images can be implemented using video data based upon the motion compensation predicting algorithm such as MPEG.

In this connection, it is to be noted that the conventional method uses the I-pictures of the MPEG data, instead of keeping the frame images at the predetermined intervals. Though the conventional method can be used without problems in the case of the data in which it is ensured that the I-pictures are spaced from each other by a constant interval, such as in MPEG-1 or 2, the method of the present invention will be effective if the interval between the I pictures is not constant or data that includes no I-picture can be created, such as in the case of MPEG-4.

However, as the reverse process is performed continuously, the image buffer 210 will eventually come into the state in which there is no remaining frame image disposed at constant intervals. As described above, it is due to the limitation of memory size of the image buffer 210. This state is shown in FIG. 6(d). The frame image 701 is the oldest frame image stored in the image buffer 210 in advance. There is no older frame image than the frame image 701 in the image buffer 210. As MPEG data typically holds only information about differences between consecutive frame images, even if only the MPEG data is obtained, the frame images cannot be created if there is no frame image acting as the base for creating the frame images. Consequently, even if the MPEG data is obtained for the purpose of creating the frame images older than the frame image 701, the frame images cannot be obtained. In order to address this problem, in this stage, the reverse reproduction using the I-pictures according to the conventional method is performed for the first time in this method. Specifically, even when the frame images are not kept, if the I-picture can be obtained from the VOD server 101, the frame images can be obtained retroactively to the I-picture. The I-picture can be located by searching the MPEG file in the VOD server 101. Assuming that the frame image 700 is the I-picture obtained as described above, the frame images up to 700, which are older than the frame image 701, can be obtained. As described above, the reverse reproduction can be performed continuously even if the frame images are not kept in the image buffer 210 due to the limitation of memory size of the image buffer 210.

However, there may be a problem in this step. The number of frames between the frame image 701 and the frame image 700 that is the I-picture depends on the type of the MPEG data. The intervals between I-pictures are constant in MPEG-1 or 2 but variable in MPEG-4. If the intervals are larger than the interval between the frame image 702 and the frame image 701, a time to obtain the MPEG data from the VOD server 101 and, thus, the value of N in FIG. 4 will be increased. On the other hand, the time difference between the frame image 702 and the frame image 701, which are being reproduced at that time, is not changed and, therefore, the value of C in FIG. 4 is also not changed. As a consequence, A+N<C may not be satisfied. If this condition is not satisfied, the reverse reproduction may seem to pause for a moment.

The expression A+N<C may be established not only when there is kept no frame image due to the limitation of memory size as described above, but also when the number of multiplication of reverse reproduction speed is large or the transmission rate of the network is low. It is because N depends on the number of multiplication of reproduction speed and the transmission rate. In this case, it is impossible to perform successive reverse reproduction (hereinafter referred to as “successive reversal”). Therefore, another reverse reproduction method is provided.

More specifically, during the reverse reproduction, only I-pictures are sent from the VOD server 101 to the audio-visual terminal 102 (hereinafter referred to as “thinned-out reversal”). As this method allows the size of MPEG data passing through the network 100 to be reduced, N is reduced in the expression A+N<C. As a consequence, the received MPEG data can be decoded immediately to obtain the frame images.

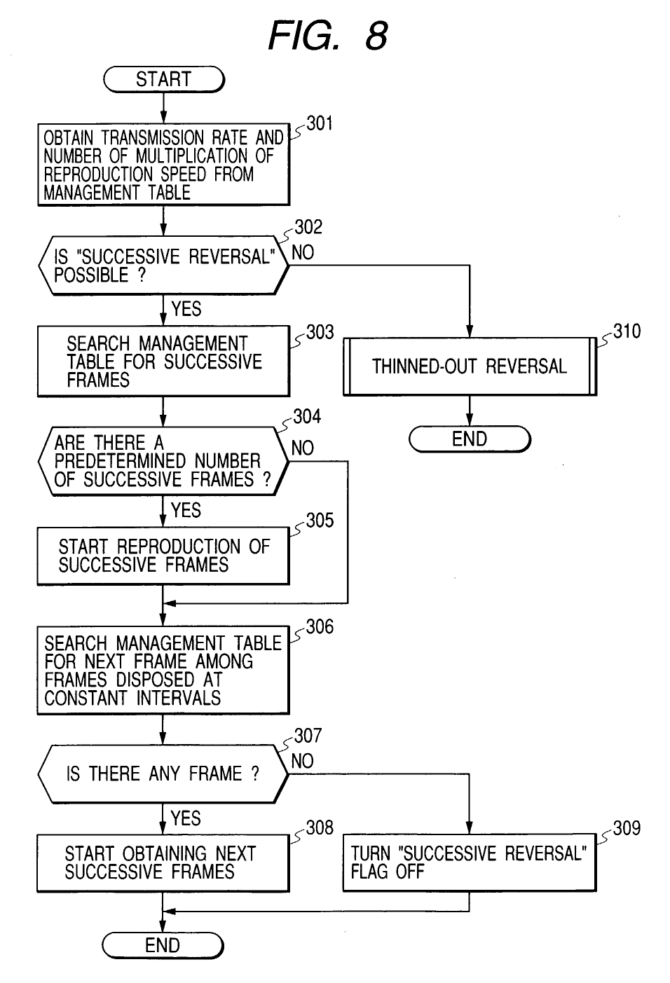

FIG. 7 shows an exemplary configuration of the management table 211 for managing the image buffer 210. In column 901, times of each frame image stored in the image buffer 210 are stored. Typically, image data such as MPEG data includes information about the times called time stamps. Here, the term “times” refers to the time stamp information. Column 902 indicates whether each frame image exists in the image buffer or not as “YES” or “NO”.

Each entry in the columns 901 and 902 is created for each frame of the MPEG data to be reproduced. But, till the reproduction is started, the columns 901 and 902 are empty. After the reproduction is started, once frame images are created by decoding, the frame images are added to the management table 211. At this time, the frame images are added so that they are sorted according to the times. Immediately after the frame image is added to the management table 211, the entry in the “existence” column is “YES”, but, when the frame image is deleted according to the process procedure described with reference to FIG. 5, the entry in the “existence” column is changed to “NO”.

Column 903 indicates the type of frames. More specifically, it identifies whether each entry is the I-picture or not. This information is used to increase efficiency for locating the I-picture when the reverse video image is created starting from the I-picture in the state in which there is kept no frame image due to the limitation of memory size.

In column 904, the current time is stored. The current time coincides with any of the times of the frames in column 901. The current time is represented in the form of hh:mm:ss:ff, wherein

hh=hour, mm=minute, ss=second, and ff=frame number.

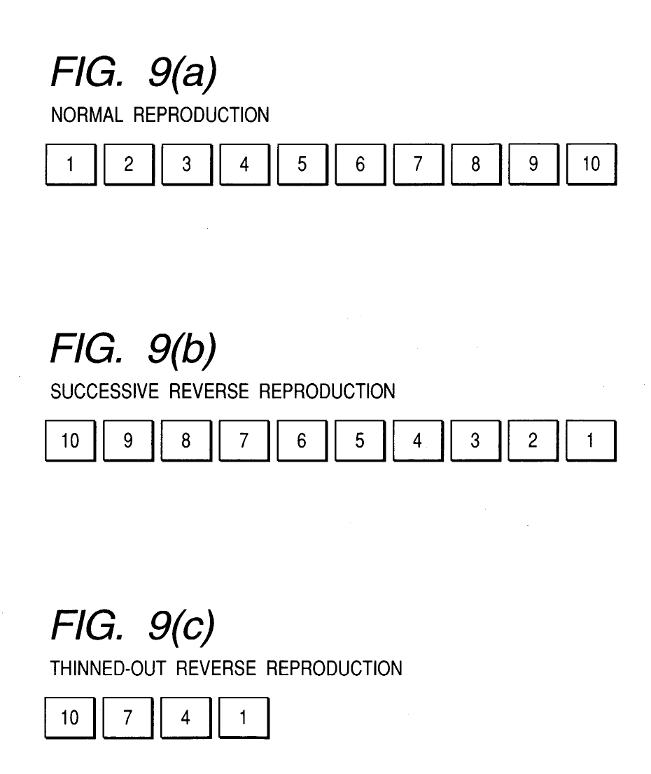

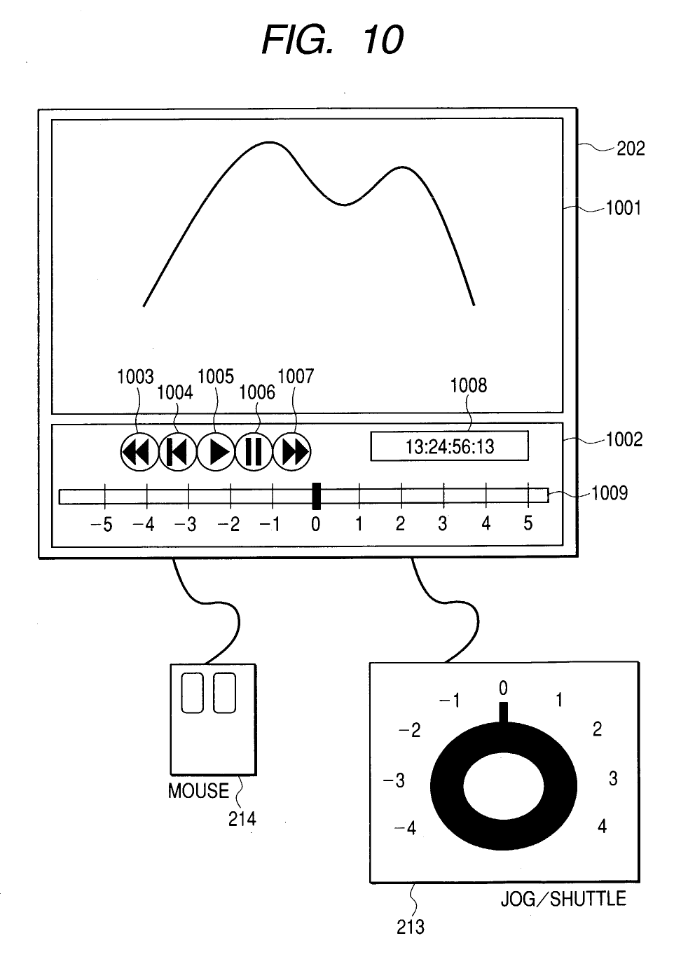

In column 905, the transmission rate is stored. This entry may be obtained from the attributes of the audio-visual terminal or manually input by the viewer. In column 906, the number of multiplication of special reproduction speed is stored. This entry may be input from the GUI unit 212, which will be described with reference to FIGS. 9(a) to 9(c).

When the reverse reproduction is performed, by referencing the management table 211, the controller 208 can know which previous frame image is kept in the image buffer 210. By knowing which frame image is kept, a request for MPEG data to reproduce frame images after the kept frame image can be issued to the VOD server 101.

As described above, the method for performing reverse reproduction differs depending on whether A+N<C can be satisfied or not. Therefore, the overall process of the reverse reproduction is as shown in a flow chart in FIG. 8.

Hereinafter, with reference to the flow chart shown in FIG. 8, the process flow of the controller 208 for performing the reverse reproduction will be described. This process procedure is performed every time when the reverse process is started in response to the instruction of the reverse reproduction and when the reverse reproduction of the predetermined number of successive frames is finished. The controller 208 obtains the transmission rate and the number of multiplication of reproduction speed from the management table 211 (step 301). Then, it is determined whether the “successive reversal” is possible (step 302). This determination depends on whether the expression described above can be satisfied by the transmission rate and the number of multiplication or not, or whether the “successive reversal” flag is ON or not.

If the “successive reversal” is possible, the controller 208 searches the management table 211 for successive frames existing in the image buffer 210 (step 303). If a predetermined number of successive frames exist (step 304 YES), the GUI unit 212 is operated to start the predetermined number of successive frames stored in the image buffer 210 (step 305). Then, the controller 208 searches the management table 211 for the second newest frame among the frames disposed at constant intervals (step 306). If there is such frame (step 307 YES), the protocol processing unit 207 is operated to start obtaining the next successive frames subsequent to the frame from the VOD server 101 (step 308). It allows the reverse reproducing operation and the operation for obtaining the compressed video data to be performed concurrently. If there is no frame (step 307 NO), the controller 208 turns the “successive reversal” flag in the program off so that the “thinned-out reversal” is performed when the reverse process is activated next time (step 309).

If it is determined that the “successive reversal” is impossible (step 302 NO), the controller 208 performs the “thinned-out reversal” (step 310). In order to delete the frame images in the image buffer 210 that have been used for reverse reproduction, the controller 208 changes each entry of the corresponding frames in the “existence” column to “NO” on the management table 211. On the other hand, every time when the frame image obtained from the VOD server 101 via the protocol processing unit 207 and the decoder 209 is stored in the image buffer 210, the controller 208 makes the entry about the frame image in the management table 211. At this time the entry of the registered frame in the “existence” column is set to “YES”.

FIGS. 9(a) to 9(c) are diagrams for describing image transition behavior in the normal reproduction, the successive reverse reproduction and the thinned-out reverse reproduction. Here, numerals in boxes are frame numbers. In contrast to the normal reproduction in which all frame images are displayed in regular order, in the successive reverse reproduction, all frame images are displayed in reverse order. Even when the image buffer 210 is supplemented with successive frame images during reproduction, the frame images are displayed on the display screen continuously without interruption. On the other hand, in the thinned-out reverse reproduction, non-successive frame images are displayed in reverse order.

FIG. 10 is a diagram showing an exemplary display screen of the display 202. The display screen consists of a region 1001 for displaying MPEG video and a control panel 1002 for inputting reproduction instructions from the viewer. Here, there are shown a button 1003 for instructing reverse reproduction, a button 1004 for instructing stop, a button 1005 for instructing normal reproduction, a button 1006 for instructing pause, and a button 1007 for instructing fast-forward reproduction. These buttons can be pushed by using the mouse 214. A region 1008 indicates the time of the currently displayed image and, by inputting an arbitrary time in this region, it also be possible to start reproduction from the input time. This “time” corresponds to the “current time” in the management table 211 shown in FIG. 7. A speed control bar 1009 specifies the number of multiplication of reproduction speed. In the shown example, a scale calibrated from −5 to 5 is provided. The location of the bar on the scale indicates the number of multiplication of reproduction speed. For example, when the bar is moved to the position of 3, it means that the triple-speed reproduction, or fast-forward reproduction is performed. This bar can also be moved by using the mouse 214. As the function of this bar is partly overlapped with the function of the buttons 1003-1007 for specifying reproduction speed, the movement of this bar is interlocked with these buttons. For example, when the bar is moved to the position of 0, the stop button 1004 is turned into the pushed state and, when the bar is moved to the position of −4, the reverse button 1003 is turned into the pushed state. In place of this speed control bar 1009, the jog/shuttle 213 may also be used. In this case, a circular device is rotated to specify the number of multiplication of speed. When the viewer moves a hand off the device, the circular device stops at the midpoint. It corresponds to the state in which the number of multiplication of reproduction speed is 0. By turning the device clockwise, accelerated reproduction speed can be specified. By turning the device at a larger angle, the number of multiplication of reproduction speed can be increased.

According to the video reproducing method of the present invention, the reverse reproduction can be performed smoothly when the reverse reproduction is instructed in the audio-visual terminal provided with such user interface.

As described above, by using the video reproducing technique of the present invention, the reverse reproduction can be implemented smoothly in the audio-visual terminal of the VOD server that distributes the compressed video data based upon the motion compensation predicting technique such as MPEG. Further, This method can be applied not only to the VOD server/client system but also to any reproduction apparatus for reproducing MPEG video in a local hard disk device.

What is claimed is:

1. A video reproducing system including a server for storing video data, and a terminal connected to the server via a network for displaying the video data, wherein
when receiving a request for reverse reproduction of a first video image from said terminal, said server reads out first compressed video data corresponding to the request from the recorded video data and transmits the first compressed video data to said terminal, and
when receiving a request for reverse reproduction of a second video image that is a continuation of said first video image, said server transmits second compressed video data corresponding to the request to said terminal, and
said terminal performs the operations of:
receiving the first compressed video data transmitted from said server,
decoding the received first compressed video data,
concurrently with the decoding process, transmitting the request for reverse reproduction of the second video image that is the continuation of said first video image to said server,
performing the reverse reproduction of said decoded first video data,
decoding the second compressed video data transmitted from said server, and
performing the reverse reproduction of said decoded second video data.

2. A video reproducing system according to claim 1, wherein said terminal,
before the reverse reproduction of said first video data is finished, determines whether the decoding of said second compressed video data is completed or not, and
as a result of said determination, if the decoding is completed, performs said second video data successively after the reverse reproduction of said first video data.

3. A video reproducing system according to claim 1, wherein, based upon a transmission rate on the network and the number of multiplication of speed of said reverse reproduction, said terminal determines whether or not to perform the reverse reproduction of said first video data and said second video image successively.

4. A video reproducing system according to claim 1, wherein
said first video image and second video image are sets of a plurality of frame images that constitute each video image, respectively, and
said server manages said video data as the plurality of frame images.

5. A video reproducing system according to claim 4, wherein said terminal, before reproducing the last frame image in the reverse reproduction process of said first video data, determines whether the decoding of the first frame image in the reverse reproduction process of said second video data is completed or not.

6. A video reproducing system according to claim 5, wherein, as a result of the determination, if the decoding of the first frame image in the reverse reproduction process of said second video data is completed, said terminal performs the reverse reproduction of said second video data successively after the reverse reproduction of said first video data.

7. A video reproducing system according to claim 1, wherein
if a portion of the video data, for which the reverse reproduction is requested, is stored, said terminal processes said portion of video data for the reverse reproduction, and
transmits a request for the reverse reproduction of video data before said portion of video data to said server.

8. A video reproducing system including a server for storing compressed video data, and a terminal connected to the server via a network for displaying the video data, wherein
said server, when receiving a request for reverse reproduction of a first video image from said terminal, transmits first compressed video data corresponding to said request to said terminal,
said terminal decodes said first compressed video data transmitted from said server,
said terminal performs the reverse reproduction of said decoded first video data,
concurrently with the decoding process, said terminal transmits a request for reverse reproduction of a second video image that is a continuation of said first video image to said server,
said server, when receiving the request for the reverse reproduction of said second video image from said terminal, transmits second compressed video data corresponding to said request,
said terminal decodes said second compressed video data from the server, and
said terminal performs the reverse reproduction of the decoded second video data.

9. A video reproducing system according to claim 8, wherein
before the reverse reproduction of said first video data is finished, said terminal determines whether the decoding of said second compressed video data is completed or not, and
if the decoding is completed, said terminal performs the reverse reproduction of said second video data successively after the reverse reproduction of said first video data.

10. A video reproducing system according to claim 9, wherein
said first video image and second video image are sets of a plurality of frame images that constitute each video image, respectively, and
when the reverse reproduction of the video data is performed, the last frame image of the first video data that is subject to the reverse reproduction and the first frame image of the second video data that is subject to the next reverse reproduction are reproduced successively.

11. A video reproducing system according to claim 8, wherein
if a portion of the video data that is subject to the reverse reproduction is stored, said terminal performs the reverse reproduction of a portion of the video data and, at the same time, transmits a request for the reverse reproduction of video data before said portion of the video data to said server.

12. A video reproducing method in a video reproducing system including a server for storing compressed video data, and a video reproducing apparatus for reproducing the video data that is transmitted from said server, the method comprising the steps of:
requesting distribution of first video data to said server;
reading out first compressed video data corresponding to the request;
transmitting the first compressed video data that is read out to said video reproducing apparatus;
decoding the transmitted first compressed video data;
requesting distribution of second video data to said server before said decoding is completed; and
performing reverse reproduction of the decoded first video data.

13. A video reproducing method according to claim 12, further comprising the steps of:
when the compressed video data corresponding to the reverse reproduction of said second video data is received, decoding such compressed video data; and
if the decoding of said second video data is completed before the reverse reproduction of said first video data is finished, performing the reverse reproduction of said second video data successively after the reverse reproduction of said first video data.

14. A video reproducing method according to claim 13, wherein said first and second video data that are subject to the reproduction are comprised of a plurality of frame images, respectively, the method further comprising the steps of:
storing a predetermined number of successive frame images that have been reproduced normally and non-successive frame images at predetermined intervals in said video reproducing apparatus;
when a request for reverse reproduction is input, performing the reverse reproduction of the predetermined number of the newest successive frame images that are stored;
requesting distribution of compressed video data between said stored non-successive frame images at the predetermined intervals to said server;
when receiving the compressed video data in response to said distribution request, decoding said compressed video data;
inserting the decoded video data between the stored frame images at the predetermined intervals; and
performing the reverse reproduction of the video data created by the insertion.

15. A video reproducing apparatus for displaying video data, comprising:
a transmitting and receiving means for transmitting a request for reverse reproduction of a first video image and receiving first compressed video data corresponding to said request;
a decoding means for decoding the first compressed video data received by said transmitting and receiving means; and
a displaying means for performing reverse reproduction of the decoded first video data,
wherein said transmitting and receiving means, concurrently with the decoding process by said decoding means, transmits a request for reverse reproduction of a second video image that is a continuation of said first video image and receives second compressed video data corresponding to the request,
said decoding means decodes the received second compressed video data, and
said displaying means performs the reverse reproduction of the second video data decoded by said decoding means.

16. A video reproducing apparatus according to claim 15, further comprising a controller for determining whether said decoding means completes the decoding process of the second compressed video data before said reproducing means finishes the reverse reproduction process of the first video data, wherein
if the decoding process of the second compressed video data is completed before the reverse reproduction process of said first video data is finished,
said displaying means performs reverse reproduction of said second video data successively after said first video data.

17. A video reproducing apparatus according to claim 16, wherein
said first video data and second video data are comprised of sets of a plurality of frame images, respectively,
said displaying means further comprising a storage means for storing a predetermined number of successive frame images of the video data that has been reproduced normally, and
said controller, if a request for reverse reproduction of the video data that has been reproduced normally is input, controls to perform the reverse reproduction using the predetermined number of successive frame images stored in said storage means.

18. A video reproducing apparatus according to claim 17, wherein
said storage means stores frame images, which are previous to said predetermined number of frame images in time, at predetermined intervals.

19. A computer program product stored in a computer readable medium that is used for a video reproducing system including a server for storing compressed image data and a terminal that is connected with said server via a network for displaying the video data, comprising:
a code for receiving a request for reverse reproduction of a first video image from said terminal and transmitting first compressed video data corresponding to said request to said terminal;
a code for decoding said first compressed video data transmitted from said server;
a code for performing the reverse reproduction of the decoded first video data;
a code for, concurrently with the decoding process, transmitting a request for reverse reproduction of a second video image that is a continuation of said first video image;
a code for receiving the request for the reverse reproduction of said second video image from said terminal and transmitting second compressed video data corresponding to said request to said terminal;
a code for decoding said second compressed video data transmitted from the server; and
a code for performing the reverse reproduction of the decoded second video data.

20. A computer program product according to claim 19, further comprising:
a code for determining whether the decoding of said second compressed video data is completed before the reverse reproduction of said first video data is finished; and
a code for, if the decoding is completed, performing the reverse reproduction of said second video data successively after the reverse reproduction of said first video data.
